(19) United States
(12) Patent Application Publication
(10) Pub. No.: US 2026/0251807 A1
(43) Pub. Date: Aug. 27, 2026

(54) Device and method for maintaining reliability of the positioning of a vehicle irrespective of the vulnerability of satellite data

(71) Applicant: THALES, MEUDON (FR)

(72) Inventors: Emmanuel NGUYEN, VALENCE (FR); Vincent CHOPARD, Védrines (FR); Thomas LESAGE, CHATELLERAULT (FR)

(21) Appl. No.: 18/877,267

(22) PCT Filed: Jul. 3, 2023
(86) PCT No.: PCT/EP2023/068209

§ 371 Date: Dec. 19, 2024

(30) Foreign Application Priority Data
Jul. 4, 2022 (FR) FR2206755

(51) Int. Cl. G01S 19/49; G01S 19/39; G01S 19/40

(52) U.S. Cl. CPC G01S 19/49; G01S 19/393; G01S 19/396; G01S 19/40

(57) ABSTRACT

A device for maintaining reliability of positioning of a vehicle irrespective of vulnerability of satellite data, including an inertial measurement unit, a satellite data receiver, a main Kalman filter configured to calculate navigation data corrections by continuous hybridization of satellite data and of non-satellite data, and, additionally, a bank of Kalman sub-filters in parallel, each Kalman sub-filter being configured to calculate navigation data corrections by intermittent hybridization, according to a predetermined recalibration frequency, and, outside the implementation of the intermittent hybridization, to calculate navigation data corrections based solely on the non-satellite data.

### CROSS-REFERENCE TO RELATED APPLICATIONS

This application claims benefit under 35 USC § 371 of PCT Application No. PCT/EP2023/068209 entitled DEVICE AND METHOD FOR MAINTAINING RELIABILITY OF THE POSITIONING OF A VEHICLE IRRESPECTIVE OF THE VULNERABILITY OF SATELLITE DATA, filed on Jul. 3, 2023 by inventors Emmanuel Nguyen, Vincent Chopard, and Thomas Lesage. PCT Application No. PCT/EP2023/068209 claims priority of French Patent Application No. 22 06755, filed on Jul. 4, 2022.

### FIELD OF THE INVENTION

The present invention relates to device for maintaining the reliability of the positioning of a vehicle irrespective of the vulnerability of satellite data, suitable for being carried on board a vehicle suitable for moving between two distinct geographical positions, the device comprising at least: an inertial measurement unit suitable for providing navigation measurements, a receiver of data, a closed-loop main Kalman filter configured to calculate corrections of navigation data by continuous hybridization of satellite positioning data provided by said receiver and of non-satellite positioning data provided by at least said inertial measurement unit.

The invention further relates to a vehicle comprising such a device for maintaining the reliability of the positioning of a vehicle irrespective of the vulnerability of satellite data.

The invention further relates to a method for maintaining the reliability of the positioning of a vehicle irrespective of the vulnerability of satellite data implemented by such a device for maintaining the reliability of the positioning of a vehicle irrespective of the vulnerability of satellite data.

The invention further relates to a computer program including software instructions which, when executed by a computer, implement such a method for maintaining the reliability of the positioning of a vehicle irrespective of the vulnerability of satellite data.

### BACKGROUND OF THE INVENTION

The present invention relates to the navigation of a vehicle apt to move between two distinct geographical positions, such as a land vehicle, an aircraft, or preferentially a naval vehicle such as a ship or else a naval vessel.

Currently, it is possible to determine the geographical position of such a vehicle using a GNSS (Global Navigation Satellite System). To this end, the vehicle generally carries a satellite navigation and positioning system receiver configured to determine, in particular by trilateration, a positioning (i.e. a geolocation position or a geolocation solution) of the aircraft using estimates of distances to visible satellites of the same or of a plurality of constellations of satellites of the satellite navigation and positioning system. Examples of satellite navigation systems are the American GPS system, the European GALILEO system, the Russian GLONASS system, the Chinese BEIDOU system, etc.

In addition, vehicles also have other navigation systems such as one or a plurality of inertial measurement units INS (Inertial Navigation System), baro-altimeters, anemometers, etc. An inertial measurement unit consists of a set of inertial sensors (accelerometers, gyrometers) associated with electronic processing systems, and provides information with little noise and accurate over the short term, but the performance thereof deteriorates over the long term, in particular because of the sensors that compose same. Such vehicles then use, for predetermined applications, a hybridization technique for position measurements known as INS/GNSS hybridization, apt to provide vehicle location with an accuracy on the same order of magnitude as GNSS location and very precise attitude and heading angles, while ensuring continuity of service when GNSS is unavailable.

However, INS/GNSS hybridization implemented using current techniques is not optimal to protect against GNSS errors in the event of satellite failure, GNSS software or hardware failure, or intentional or unintentional interference, nor to provide integrated positioning when such errors occur.

### SUMMARY OF THE DESCRIPTION

The goal of the invention is then to propose a navigation and positioning device which at least makes it possible to maintain the integrity of the positioning independently of the vulnerability of the GNSS measurements.

To this end, the invention provides a device for maintaining the reliability of the positioning of a vehicle irrespective of the vulnerability of satellite data suitable for being carried on-board a vehicle suitable for moving between two distinct geographical positions, the device comprising at least:
an inertial measurement unit suitable for providing navigational measurements,
a receiver of satellite positioning data,
a closed-loop main Kalman filter configured to calculate navigation data corrections by continuous hybridization of satellite positioning data provided by said receiver and non-satellite positioning data provided by at least said inertial measurement unit, the device further comprising a bank of N Kalman sub-filters in parallel, with N a predetermined integer such that N>1, each Kalman sub-filter being configured to:
calculate navigation data corrections by intermittent hybridization, according to a resetting frequency F_{Ri} comprised within a predetermined frequency range, of satellite positioning data provided by said receiver and non-satellite positioning data provided at least by said inertial measurement unit, said resetting frequency being distinct from one sub-filter to another;
   outside the implementation of said intermittent hybridization, calculate navigation data corrections solely from the non-satellite positioning data provided by at least said inertial measurement unit.

Thereby, the navigation and positioning device according to the invention has a particular architecture where each Kalman sub-filter is apt to compensate for the drift thereof, relating to the computation of the corrections of navigation data solely on the basis of the non-satellite positioning data provided at least by said inertial measurement unit, by resetting itself intermittently on a solution using the satellite data, according to a different resetting frequency from one sub-filter to another.

In other words, the particular architecture of the device for maintaining the reliability of the positioning of a vehicle irrespective of the vulnerability of satellite data according to the present invention makes it possible to perform a time-shifted resetting from one sub-filter to another, the resetting frequency being distinct from one sub-filter to another.

Outside such an intermittent resetting, none of the Kalman sub-filters uses GNSS measurements as input to calculate the navigation data corrections thereof, making each of the same invulnerable to a possible GNSS error.

Furthermore, the long-term degradation of the performance of the Kalman sub-filters is limited. Indeed, such degradation is conventionally due to a drift of the position measurements received at input and obtained only from the non-satellite measurements provided at least by said inertial measurement unit, and, according to the present invention, is limited by means of said intermittent resetting by intermittent hybridization with satellite data, which means intermittently to reproduce the processing performed by the main Kalman filter. In other words, the intermittent hybridization “is equivalent to” a reconfiguration on the main Kalman filter.

In other words, the resetting frequency makes it possible, for each Kalman sub-filter, to take advantage of the short-term precision of the position measurements, received at input, and obtained only from the non-satellite measurements provided at least by said inertial measurement unit, while preventing the medium/long term associated computation drift.

According to other advantageous aspects of the invention, the device for maintaining the reliability of the positioning of a vehicle irrespective of the vulnerability of satellite data comprises one or a plurality of the following features, taken individually or according to all technically possible combinations:
the N Kalman sub-filters being identical and independent, the 1/F_{Ri} corresponding to a verification period of the reliability of said positioning measurements by GNSS satellites,
the device is further configured to:
   check, the reliability of said positioning measurements by GNSS satellites by comparing, with a predetermined threshold, the difference, outside the implementation of said intermittent hybridization, and the state of the main Kalman filter, and
in case of difference greater than said predetermined threshold, raise an alarm suitable for signaling a vulnerability of said positioning measurements by GNSS satellites;
the device is also configured to determine said predetermined threshold as a function of a probability of false alarm;
in the event of a raising of alarm, the main Kalman filter is also configured to reconfigure itself on a predetermined Kalman sub-filter of index p with 1≤p≤N.
said predetermined Kalman sub-filter of index p on which the main Kalman filter is suitable for being reconfigured in the event of a raising of alarm, is the Kalman sub-filter among said N Kalman sub-filters the implementation of which of said intermittent hybridization is the farthest, in terms of time, from the moment of raising of alarm;
said main Kalman filter is configured to no longer use as input said positioning measurements by GNSS satellites from the moment when the main Kalman filter initiates the reconfiguration thereof;
in the event of a raising of alarm, each Kalman sub-filter of index i≠p is also configured to reconfigure on said predetermined Kalman sub-filter of index p;
the device is also configured to determine a radius of protection against a vulnerability of said positioning measurements by GNSS satellites, said radius of protection ensuring that the value of the distance between the hybrid position provided from said main Kalman filter and the true position of said vehicle is less than the value of said radius of protection, said radius of protection depending on the number N of Kalman sub-filters;
the device is also configured to provide, at the output, in parallel, navigation solutions associated with said bank of N Kalman sub-filters and with said main Kalman filter, respectively.

A further subject matter of the invention is a vehicle comprising such a device for maintaining the reliability of the positioning of a vehicle irrespective of the vulnerability of satellite data.

A further subject matter of the invention relates to a method for maintaining the reliability of the positioning of a vehicle irrespective of the vulnerability of satellite data and comprising the following steps implemented in parallel or successively one after the other or vice versa:
locating said vehicle using the corrections provided by the main Kalman filter and by each by the bank of N Kalman sub-filters, respectively,
verification of the reliability of the said positioning measurements by GNSS satellites, said verification comprising:
   the determination of the state of each Kalman sub-filter, apart from the implementation of said intermittent hybridization (i.e. if one of the sub-filters is in resetting by intermittent hybridization, the state thereof is not determined because same will then be identical to the state of the main Kalman filter), and the state of the main Kalman filter,
   the determination of a threshold suitable for comparison with the difference between the state of each Kalman sub-filter and the state of the main Kalman filter,
   the comparison of the difference between the state of each sub-filter, outside the implementation of said intermittent hybridization, with the state of the main Kalman filter at said threshold,
in the presence of a difference greater than said predetermined threshold:
   the raising of an alarm apt to signal a vulnerability of the said positioning measurements by GNSS satellites,
   the reconfiguration of the main Kalman filter on a predetermined Kalman sub-filter of index p with 1≤p≤N,
   the deselection of the input of the main Kalman filter dedicated to the positioning measurements by GNSS satellites from the moment when the main Kalman filter initiates the reconfiguration thereof,
   the reconfiguration of each Kalman sub-filter of index i≠p on said predetermined Kalman sub-filter of index p,
in the absence of a difference greater than said predetermined threshold, the determination of a radius of protection against a vulnerability of said positioning measurements by GNSS satellites, said radius of protection ensuring that the value of the distance between the hybrid position provided from said main Kalman filter and the true position of said vehicle is less than the value of said radius of protection, said radius of protection depending on the number of Kalman sub-filters.

According to a particular aspect of said method, said location step comprises the provision at output, in parallel, of navigation solutions associated with said bank of N Kalman sub-filters and with said main Kalman filter, respectively.

A further subject matter of the invention is a computer program including software instructions which, when executed by a computer, implement a such a method for maintaining the reliability of the positioning of a vehicle irrespective of the vulnerability of satellite data, as defined hereinabove.

### BRIEF DESCRIPTION OF THE DRAWINGS

Such features and advantages of the invention will become clearer upon reading the following description, given only as a non-limiting example, and made with reference to the enclosed drawings, wherein:

FIG. 1 is a diagram illustrating a navigation and positioning device suitable for implementing an INS/GNSS hybridization, and optionally with supplementary measurements provided by equipment distinct from a satellite data receiver and distinct from said inertial measurement unit;

FIG. 2 is a diagram illustrating the architecture of the bank of Kalman filters according to the present invention;

FIG. 3 illustrates the closed-loop principle;

FIG. 4 is a flowchart of a method for maintaining the reliability of the positioning of a vehicle irrespective of the vulnerability of satellite data.

### DETAILED DESCRIPTION OF EMBODIMENTS

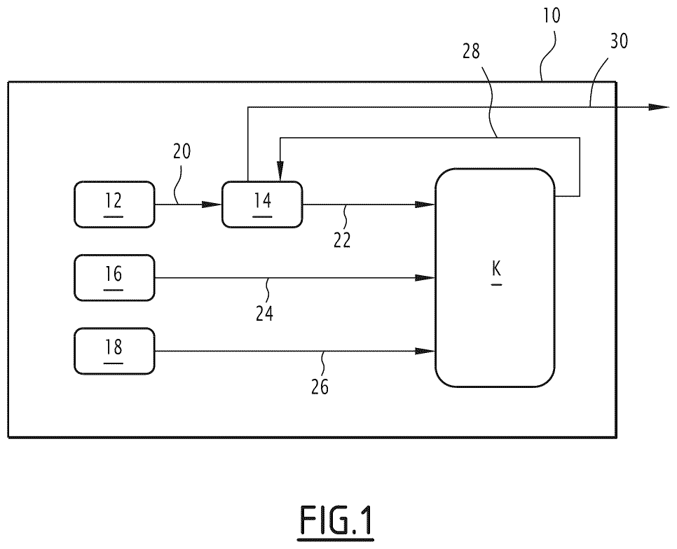

FIG. 1 is an overall representation of a device 10 for maintaining the reliability of the positioning of a vehicle irrespective of the vulnerability of satellite data according to the present invention, suitable for implementing an INS/GNSS hybridization, and optionally with supplementary measurements provided by equipment distinct from a satellite data receiver and distinct from said inertial measurement unit, and comprising at least one inertial measurement unit 12 suitable for providing navigation measurements, in particular to a virtual computation and location platform 14, a receiver 16 satellite data (i.e. a receiver of positioning measurements by GNSS satellites), and optionally a receiver 18 of supplementary measurements provided by at least one item of equipment distinct from said receiver 16 of satellite data and distinct from said inertial measurement unit 12 and finally a set K of Kalman filters.

The inertial measurement unit 12 consists of a set of inertial sensors such as gyrometers and accelerometers associated with electronic processing components and is suitable for providing increments 20 of angular rotation and speed of the vehicle wherein the device 10 for maintaining the reliability of the positioning of a vehicle irrespective of the vulnerability of satellite data is carried on-board.

The virtual computation platform 14 integrates such increments 20 of angular rotation and of speed in order to provide, at the input to the main Kalman filter, navigation data 22, such as the orientation of the vehicle (i.e. the attitude thereof), in terms of roll, pitch, yaw, heading, etc., the speed of the vehicle, e.g. the speed Vnorth along the North direction, the speed Veast along the East direction, the speed Vlow at the lower part of the trajectory, etc., and the position of the vehicle e.g. in terms of latitude, longitude, altitude.

The receiver 16 of satellite data (i.e. GNSS receiver) is suitable for providing, along the direction of the arrow 24, information on the position and speed of the vehicle by triangulation from signals transmitted by moving satellites visible from the vehicle. The information provided may be temporarily unavailable because, in order to be able to establish a point, the receiver has to have direct view on a minimum of four satellites of the positioning system. Furthermore, the information have variable accuracy, depending on the geometry of the constellation at the base of the triangulation, and noisy because same rely on the reception of very low level signals coming from distant satellites having low transmission power. However, the information is not affected by long-term drift, the positions of satellites passing through the orbits thereof being known precisely over the long term. Noise and errors may be related to satellite systems, to the receiver, or to the propagation of the signal between the satellite transmitter and the receiver of GNSS signals. Furthermore, satellite data may be erroneous due to satellite failures. Such affected data must then be identified so as not to distort the position coming from the GNSS receiver.

The optional receiver 18 of supplementary measurements 26 provided by at least one item of equipment distinct from said receiver 16 of satellite data and distinct from said inertial measurement unit 12 provides e.g. a zero displacement resetting when the vehicle is stationary, an Electromagnetic Loch measurement and a dynamic model of the vehicle, a Doppler loch or a measurement of velocity in water when the equipment is a DVL (Doppler Velocity Log), a measurement of depth, a resetting by radar, by imaging, by signals of opportunity, etc.

The hybridization implemented by the set of Kalman filters consists in mathematically combining the measurements 22, 24, 26 provided by the inertial measurement unit 12, the receiver 16 of GNSS positioning measurements, and the optional receiver 18 of supplementary measurements 26, respectively, in order to obtain position and speed information by taking advantage of the three elements 12, 16 and 18.

Kalman filtering is based on the possibilities of modeling the evolution of the state of a physical system considered in the environment thereof, by means of a so-called “evolution” equation (a priori estimation), and of modeling the relation of dependence existing between the states of the physical system considered and the measurements of an external sensor, by means of a so-called “observation” equation for a resetting of the states of the filter (a posteriori estimation). In a Kalman filter, the effective measurement or “measurement vector” makes it possible to produce an a posteriori estimate of the state of the system which is optimal in the sense that the estimate minimizes the covariance of the error made on the estimate. The estimator part of the filter generates a posteriori estimates of the state vector of the system by using the difference found between the effective measurement vector and the a priori prediction thereof, to generate a corrective term, called innovation. The innovation, after a multiplication by a gain vector of the Kalman filter, is applied to the a priori estimate of the state vector of the system and leads to the obtaining of the a posteriori optimum estimate.

The Kalman filtering implemented by the set K of Kalman filters models the evolution of the errors of the inertial measurement unit 12 and delivers the a posteriori estimate of the errors which is used to correct the positioning and speed point of the inertial measurement unit 12.

The correction 28 of the errors by means of the estimation thereof made by the set K of Kalman filters is then carried out at the input of the virtual platform 14 according to a so-called “closed-loop” architecture as illustrated by FIG. 1 making it possible to keep navigation errors low and thus to stay in the linear domain of the set K of Kalman filters. The virtual platform 14 uses such a correction 28 to develop the optimal estimate 30 of the position and speed of the vehicle.

The hybridization is called “loose” (or geographic axis hybridization) when the receiver 16 of satellite data provides the position and the speed of the vehicle resolved by the GNSS receiver 16.

The hybridization is called “tight” when the receiver 16 of satellite data provides the information extracted upstream by the GNSS receiver, namely pseudo-distances and pseudo-speeds (quantities directly derived from the measurement of the propagation time and from the Doppler effect of the signals transmitted by the satellites toward the receiver).

With such a device 10 for maintaining the reliability of the positioning of a vehicle irrespective of the vulnerability of satellite by closed-loop INS/VEH/GNSS hybridization where the point solved by the GNSS receiver 16 is used to reset the information coming from the inertial measurement unit 12, it is necessary to monitor the defects affecting the information provided by the satellites because the receiver 16 which receives same will propagate the defects to the inertial measurement unit 12, leading to a wrong resetting of the latter.

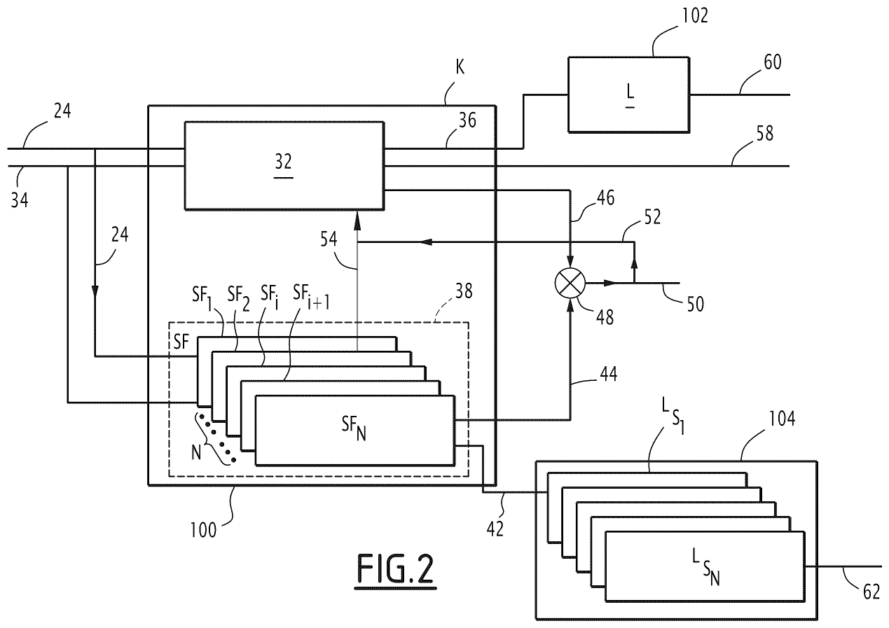

To this end, the set K of Kalman filters according to the present invention has a particular architecture 100 illustrated in FIG. 2.

The set K comprises firstly a main Kalman filter 32 in closed-loop configured to implement a continuous hybridization of the satellite positioning data provided by said receiver 16 and non-satellite positioning data provided at least by said inertial measurement unit, in other words a hybridization of position measurements received at input and obtained from said positioning measurements 24 by GNSS satellites, and from the measurements 34 provided both by said inertial measurement unit 12 and by said optional receiver 18 of complementary measurements, respectively, in order to calculate corrections 36 to navigation data. Continuous hybridization means that hybridization is constantly implemented outside the reconfiguration period of the main Kalman filter 32 as discussed in detail below in the event of a detected lack of reliability of the satellite data.

The set K further comprises, according to the present invention, a bank SF of N Kalman sub-filters SF₁, SF₂, . . . . SFᵢ, SFᵢ₊₁, . . . . SF_{N}, in parallel with each other, and operating at deviations (i.e. the correction established by the primary filter being applied, as discussed in detail thereafter, to the propagation phase of each Kalman sub-filter) with N a predetermined integer such that N≥1, or preferably N>1, each Kalman sub-filter being configured to:
calculate navigation data corrections by intermittent hybridization, according to a resetting frequency F_{R} within a predetermined frequency range, of satellite positioning data provided by said receiver and non-satellite positioning data provided at least by said inertial measurement unit, said resetting frequency being distinct from one sub-filter to another;
outside the implementation of said intermittent hybridization, calculate navigation data corrections solely from the non-satellite positioning data provided by at least said inertial measurement unit.

The resetting is e.g. suitable for being performed every minute (i.e. a resetting frequency F_{R} equal to once per minute, or again every day (i.e. once per twenty-four hours), or again every two days (i.e. once per forty-eight hours), so that it is considered, e.g., that the resetting frequency F_{R} is within the range defined by the maximum limit “once per minute” and the minimum limit “once per forty-eight hours” with the possibility of being equal to one of the bounds.

For example, the first Kalman sub-filter SF₁₍ᵢ₌₁₎ implements an intermittent hybridization, according to a resetting frequency F_{R1}, e.g. a non-limiting frequency of the order of one minute, of satellite positioning data provided by said receiver and non-satellite positioning data provided at least by said inertial measurement unit. In other words, the first Kalman sub-filter SF₁ uses satellite data once a minute and does not otherwise use same outside said single time per minute, which means that once a minute SF₁ operates identically as the main Kalman filter 32.

The second Kalman sub-filter SF_{2 (i=2)} implements an intermittent hybridization, according to a resetting frequency F_{R2}, e.g. a non-limiting frequency on the order of half an hour (i.e. 30 minutes), of satellite positioning data provided by said receiver and non-satellite positioning data provided by at least said inertial measurement unit. In other words, the second Kalman sub-filter SF₂ uses satellite data once every half hour (i.e. every 30 minutes) and does not otherwise use same outside said one time per half hour, which means that once every half hour SF₂ operates identically as the main Kalman filter 32.

The third Kalman sub-filter SF_{3 (i=3)} implements an intermittent hybridization, according to a resetting frequency F_{R3}, e.g. a non-limiting frequency on the order of one hour, of satellite positioning data provided by said receiver and non-satellite positioning data provided at least by said inertial measurement unit. In other words, the second Kalman sub-filter SF₃ uses satellite data once an hour and does not use same otherwise outside said one time per hour, which means that once an hour SF₃ operates identically as the main Kalman filter 32, and so on for the following sub-filters SF_{4 (i=4)} up to SF_{N} the Nth sub-filter which implements, e.g. an intermittent hybridization, according to a resetting frequency F_{R3}, for a non-limiting, on the order of the order of the day (i.e. every twenty-four hours).

It should be noted that the resetting time as such is in particular less than the period 1/F_{Ri}. More precisely, the resetting duration as such generally depends on the inertial measurement unit (also called inertial unit) and is a fraction of the inverse of the resetting frequency 1/F_{Ri}, e.g. twenty seconds if the resetting frequency is of one resetting every two hundred seconds. It should be noted that the resetting duration may be fixed according to a first optional variant, e.g. twenty seconds for all the sub-filters, or variable according to a second optional variant of the present invention, the resetting frequency F_{R} and/or the resetting duration then being distinct from one sub-filter to another and/or associated with a triggering instant (i.e. start moment of the activity of the sub-filter considered) distinct from one sub-filter to another.

For example, if one considers the Nth sub-filter which implements once a day (i.e. every twenty-four hours) a resetting on a solution using satellite data, the resetting duration as such is on the order of one hundred seconds, whereas if one considers the 1^{st} sub-filter SF₍ᵢ₌₁₎ which implements an intermittent hybridization, according to a resetting frequency F_{R1}, e.g. which is non-limiting on the order of one minute, the resetting order as such being shorter and e.g. on the order of forty seconds.

Moreover, each Kalman sub-filter SF₁, SF₂, . . . . SFᵢ, SFᵢ₊₁, . . . . SF_{N}, outside the implementation of said intermittent hybridization, is configured to calculate corrections 42 of navigation data solely from the non-satellite positioning data provided at least by said inertial measurement unit, in particular herein by hybridization of position measurements received at input and obtained only from measurements 34 provided by said inertial measurement unit 12 and provided by said optional receiver 18 of supplementary measurements, and does not accept at input, to perform the computation outside the implementation of said intermittent hybridization, unlike the main Kalman filter 32, the positioning measurements 24 by GNSS satellites.

According to a more basic embodiment (not shown), each Kalman sub-filter SF₁, SF₂, . . . . SFᵢ, SFᵢ₊₁, . . . . SF_{N}, outside the implementation of said intermittent hybridization, is configured to calculate corrections 42 of navigation data, solely from the non-satellite positioning data provided by said inertial measurement unit, dispensing with the non-satellite data provided by the optional receiver 18.

According to an optional variant, the N Kalman sub-filters SF₁, SF₂, . . . . SFᵢ, SFᵢ₊₁, . . . . SF_{N} are identical and independent, the period 1/Fri_{Ri}, distinct from one sub-filter to another, corresponding to a verification period of the reliability of said positioning measurements 24 by GNSS satellites, by means of each sub-filter distinctly.

According to a particular variant of the present invention, the device 10, part of which is shown in FIG. 2, is also configured to check the reliability of said positioning measurements by GNSS satellites by comparing, at a predetermined threshold, the difference between the state 44 of each sub-filter SF₁, SF₂, . . . . SFᵢ, SFᵢ₊₁, . . . . SF_{N} and the state 46 of the main Kalman filter 32. The element 48 of FIG. 2 determines such a difference and compares same with a predetermined threshold 50.

In case of difference greater than said predetermined threshold 50, the device 10 is configured to raise, along the arrow 52 of FIG. 2, an alarm suitable for signaling a vulnerability of said positioning measurements by GNSS satellites.

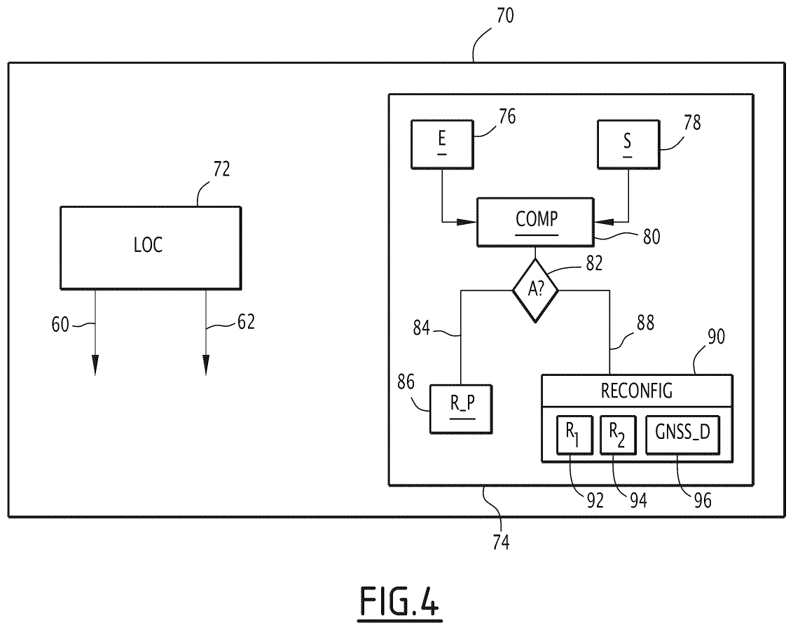

As an optional addition, the device 10 is also configured, by means of a computation tool not shown in FIG. 2, to determine said predetermined threshold 50 as a function of a probability of false alarm, as discussed in detail below in relation to FIG. 4.

As an optional addition, as illustrated by the embodiment represented by FIG. 2, in the case of raising of alarm illustrated by the arrow 52, the main Kalman filter 32 is also configured to reconfigure itself, along the arrow 54, on a predetermined Kalman sub-filter SFₚ of index 1≤p≤N with p. “Reconfigure itself” means that the main Kalman filter 32 is suitable for copying the state vector and the covariance matrix of the Kalman sub-filter SFₚ.

According to a supplementary variant of the optional addition, said predetermined Kalman sub-filter SFₚ of index p on which the main Kalman filter 32 is apt to reconfigure itself, along the arrow 54, in case of raising of alarm 52, is the Kalman sub-filter among said N Kalman sub-filters, the implementation of the intermittent hybridization of which is the farthest, in terms of time, from the moment of raising of alarm.

According to another supplementary variant of the optional addition, said main Kalman filter 32 is configured to no longer use said positioning measurements by GNSS satellites 24 as input from the moment when the main Kalman filter 32 initiates the reconfiguration thereof. In other words, as soon as the reconfiguration of the main Kalman filter 32 is ordered, the positioning measurements 24 by GNSS satellites (the vulnerability of which is detected) are no longer used e.g. by sending a deselection command for the measurements at the input to the set K of Kalman filters.

According to another supplementary variant of the optional addition, in case of raising of alarm 52, each Kalman sub-filter of index i≠p is also configured to reconfigure itself on said predetermined Kalman sub-filter of index p, which makes it possible to restore a completely healthy set K of main Kalman filters 32 and Kalman sub-filters SF₁, SF₂, . . . . SFᵢ, SFᵢ₊₁, . . . . SF_{N}.

According to another optional supplementary aspect, the device 10 is also configured to determine a radius of protection 58 against a vulnerability of said positioning measurements by GNSS satellites, said radius of protection ensuring that the value of the distance between the hybrid position 30 provided from said main Kalman filter 32 and the true position of said vehicle is less than the value of said radius of protection 58, said radius of protection 58 depending on the number N of Kalman sub-filters.

In order to quantify the reliability of a position measurement in applications such as naval or aeronautical applications, where reliability is critical, such a radius of protection parameter for the position measurement is generally used. The radius of protection generally corresponds to a maximum position error for a given probability of error occurrence, i.e. the probability that the position error exceeds the announced radius of protection without an alarm being sent to a navigation system, is less than the given probability value. The computation is based on two types of error which are, on the one hand, normal measurement errors and, on the other hand, errors caused by an anomaly in the operation of the constellation of satellites, meaning e.g. a failure of a satellite. The value of the radius of protection of a positioning system is a key value specified by contractors wishing to acquire a positioning system. The evaluation of the value of the radius of protection generally results from probability computations using the statistical characteristics of the precision of GNSS measurements and of the behavior of inertial sensors. Such computations are explained formally and allow simulations to be made for all GNSS constellation cases, for all possible positions of the positioning system on the terrestrial globe and for all possible trajectories followed by the positioning system. The results of these simulations make it possible to provide the ordering party with radius of protection characteristics guaranteed by the proposed positioning system. Most often, such characteristics are expressed in the form of a value of the radius of protection for an availability of 100% or of an unavailability time for a required value of the radius of protection.

The determination of the radius of protection implemented according to the present invention using the particular architecture 100 of the set K of Kalman filters is described hereinafter in more detail in relation to FIG. 4.

According to another optional supplementary aspect, the device 10 is also configured to provide, in parallel at the output, navigation solutions 60 and 62 associated with said main Kalman filter and with said bank 38 of N Kalman sub-filters, respectively, via the modules of determination of navigation solutions 102 and 104, respectively.

In other words, the device 10 according to the present invention makes possible a parallel navigation by distinct Kalman filters, namely via the navigation solutions 62 associated with the N Kalman sub-filters SF₁, SF₂, . . . . SFᵢ, SFᵢ₊₁, . . . . SF_{N} and via the navigation solutions 60 correspondingly associated with the main Kalman filter 32. Such an architecture 100 thereby provides secondary navigation solutions (associated with each sub-filter), in terms of position, speed, attitude, in parallel with the solution provided by the primary filter, such secondary navigation solutions being suitable for being useful for certain types of navigation, in particular underwater navigation.

For example, for the position, at each cycle of the main Kalman filter 32, the device 10 according to the present invention is apt to apply the correction Cor^{SF} of each Kalman sub-filter SF₁, SF₂, . . . . SFᵢ, SFᵢ₊₁, . . . . SF_{N} to the primary position state X_{n+1/n} (i.e. associated with the primary solution INS/GNSS delivered by the main Kalman filter 32, n and n+1 being successive times) to obtain the position state

$${X}_{n + 1 / n}^{S F}$$

associated with the sub-filter SF:

$$C o {r}_{n + 1}^{S F} = {X}_{n + 1 / n}^{S F} - C o {r}_{n + 1} = {X}_{n + 1 / n}^{S F} - {X}_{n + 1 / n} ,$$

and the same for the Lat^{SF}, longitude Lon^{SF}, and altitude Alt^{SF}, such as:

$${Lat}^{S F} = L a {t}^{INS / GNSS} + C o {r}^{S F} ( L a t ) ,$$

$$Lo {n}^{S F} = L o {n}^{INS / GNSS} + C o {r}^{S F} ( Lon ) {Alt}^{S F} = A l {t}^{INS / GNSS} + C o {r}^{S F} ( Alt )$$

According to a variant (not shown), the device 10 for maintaining the reliability of the positioning of a vehicle irrespective of the vulnerability of satellite data according to the present invention comprises a processing unit consisting e.g. of a memory and a processor associated with the memory, and the device 10 is at least in part made in the form of software, or of a software brick, executable by the processor, in particular the set K of Kalman filters, the virtual computation and location platform 14, the element 48 of FIG. 2 configured to determine a difference between the state of each sub-filter, outside the implementation of said intermittent hybridization, and the main Kalman filter, and to compare the difference with the predetermined threshold 50 and optionally the computation tool configured to determine said threshold 50. The memory of the device 10 for maintaining the reliability of the positioning of a vehicle irrespective of the vulnerability of satellite data is then apt to store such software or software bricks, and the processor is then apt to execute same.

In a variant (not shown), the set K of Kalman filters, the virtual computation and location platform 14, the element 48 of FIG. 2 configured to determine a difference between the state of each sub-filter and the state of the main Kalman filter, and to compare the difference with a predetermined threshold 50, and optionally the computation tool configured to determine said threshold 50, are each implemented in the form of a programmable logic component, such as an FPGA (Field Programmable Gate Array), or else in the form of a dedicated integrated circuit, such as an ASIC (Application Specific Integrated Circuit).

When at least a part of the device 10 for maintaining the reliability of the positioning of a vehicle irrespective of the vulnerability of satellite data to the invention is produced in the form of one or a plurality of software programs, i.e. in the form of a computer program, such part is further apt to be stored on a computer-readable medium (not shown). The computer-readable medium is e.g. a medium apt to store the electronic instructions and to be coupled to a bus of a computer system. As an example, the readable medium is an optical disk, a magneto-optical disk, a ROM memory, a RAM memory, any type of non-volatile memory (e.g. EPROM, EEPROM, FLASH, NVRAM), a magnetic card or further an optical card. A computer program containing software instructions is then stored on the readable medium.

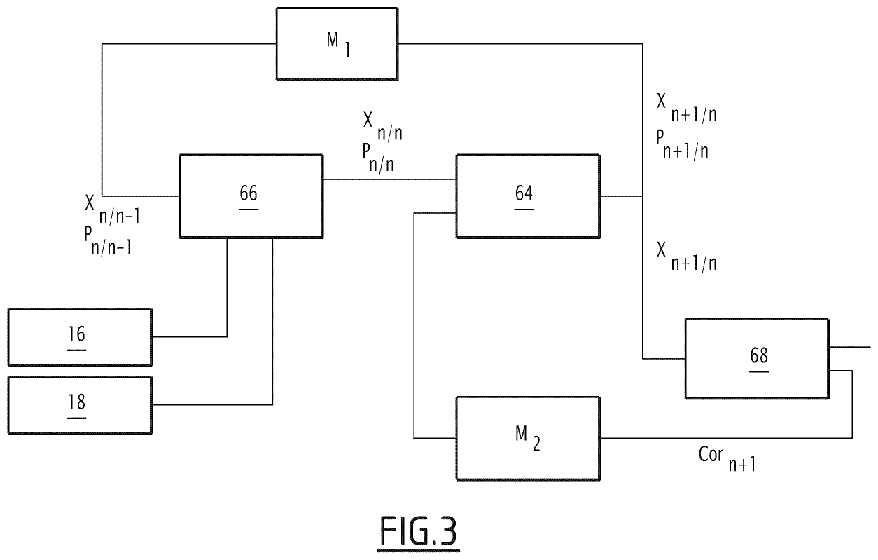

FIG. 3 illustrates the closed-loop principle applied to the main Kalman filter 32, with the position state X of the main Kalman filter 32, and P the covariance matrix thereof. A propagation module 64 of the main Kalman filter 32 is configured to propagate the state using the navigation equations, and a resetting module 66 is used to estimate the state using the GNSS measurements provided by said receiver 16 of satellite data and the measurements of the optional receiver 18 of supplementary measurements provided by at least one item of equipment distinct from said receiver 16 of satellite data and distinct from said inertial measurement unit 12. The propagation and closed-loop resetting equations are for the resetting implemented by the module 66:

$${K}_{n} = {P}_{n / n - 1} \cdot {{H}^{T} ( {R}_{n} + H \cdot {P}_{n / n - 1} \cdot {H}^{T} )}^{- 1}$$

$${X}_{n / n} = {X}_{n / n - 1} + {K}_{n} \cdot ( {Z}_{n} - H \cdot {X}_{n / n - 1} )$$

$${P}_{n / n} = ( I - {K}_{n} \cdot H ) {P}_{n / n - 1}$$

and for the propagation implemented by the module 64:

$${P}_{n + 1 / n} = {F}_{n + 1} \cdot {P}_{n / n} \cdot {F}_{n + 1}^{T} + {Q}_{n + 1}$$

$${X}_{n + 1 / n} = {F}_{n + 1} \cdot {X}_{n / n} - C o {r}_{n}$$

$$Co {r}_{n + 1} = {X}_{n + 1 / n}$$

with F the propagation matrix, Q the model noise matrix, R the measurement noise covariance matrix, H the observation matrix, K the Kalman gain and Z the observation vector obtained from the receiver 16 and from 18, X_{n+1/n} the position state vector propagated after propagation between the two successive times n and n+1. The correction Corₙ₊₁ is applied by a correction module 68 to the navigation data to obtain the position state X_{n+1/n+1} and stored in the memory M₂, as well as the covariance matrix P_{n+1/n} in the memory M₁, for a subsequent iteration at the moment n+1.

The principle also applies to each Kalman sub-filter (i.e. sub-filter) SF₁, SF₂, . . . . SFᵢ, SFᵢ₊₁, . . . . SF_{N} each sub-filter SF₁, SF₂, . . . . SFᵢ, SFᵢ₊₁, . . . . SF_{N} using the observation matrix H, the measurement noise R and the measurements Z of the observations coming from the receiver 18 of supplementary measurements provided by at least one item of equipment distinct from said receiver 16 of satellite data and distinct from said inertial measurement unit 12, a set K of Kalman filters, and, outside the implementation of said intermittent hybridization, without using the measurements coming from the receiver 16 of satellite data (i.e. when the sub-filter considered does not implement an intermittent hybridization, the sub-filter does not use any of the GNSS measurements coming from the receiver 16 of satellite data).

More precisely, for each Kalman sub-filter SF₁, SF₂, . . . . SFᵢ, SFᵢ₊₁, . . . . SF_{N}, conventional Kalman filter equations are used by applying the INS/GNSS correction Cor of the main Kalman filter 32 at the moment of propagation.

The propagation and resetting equations are thus for the resetting implemented within each Kalman sub-filter operating at differences (i.e. the correction established by the primary filter being applied, as discussed in detail below, to the propagation phase of each Kalman sub-filter):

$${K}^{SF} = {P}_{n / n - 1}^{SF} \cdot {{H}^{{SF}^{T}} ( R + {H}^{SF} \cdot {P}_{n / n - 1}^{SF} \cdot {H}^{{SF}^{T}} )}^{- 1}$$

$${X}_{n / n}^{SF} = {X}_{n / n - 1}^{SF} + {K}^{SF} \cdot ( {Z}^{SF} - {H}^{SF} \cdot {X}_{n / n - 1}^{SF} )$$

$${P}_{n / n}^{SF} = ( I - {K}^{SF} \cdot {H}^{SF} ) {P}_{n / n - 1}^{SF}$$

and for the propagation:

$${P}_{n + 1 / n}^{SF} = F \cdot {P}_{n / n}^{SF} \cdot {F}^{T} + Q$$

$${X}_{n + 1 / n}^{SF} = F \cdot {X}_{n / n}^{SF} - {Cor}_{n}$$

with Corₙ the correction coming from the main Kalman filter 32, Z^{SF} the observation vector which is a subset of Z of the main Kalman filter 32 containing only the observations obtained from the receiver 18, and not from the receiver 16 of satellite data when the sub-filter considered does not implement any intermittent hybridization, H^{SF} the observation matrix which contains the lines of H of the main Kalman filter 32 linked to the observations of the sub-filter considered in turn (i.e. in other words H^{SF} contains zeros for the part associated with the positioning measurements by GNSS satellites) K^{SF} is the sub-filter considered for the covariance matrix of the Kalman filter for the sub-filter considered.

An example of the operation of device 10 for maintaining the reliability of the positioning of a vehicle irrespective of the vulnerability of satellite data according to the present invention will now be described hereinafter with reference to FIG. 4.

More precisely, the method 70 for maintaining the reliability of the positioning of a vehicle irrespective of the vulnerability of satellite data implemented by said device 10 for maintaining the reliability of the positioning of a vehicle irrespective of the vulnerability of satellite data comprises the steps described hereinafter, implemented in parallel or successively one after the other or vice versa.

According to step 72, as indicated hereinabove, the device 10 for maintaining the reliability of the positioning of a vehicle irrespective of the vulnerability of satellite data according to the present invention implements a location of said vehicle by using the corrections provided by the main Kalman filter and by the bank of N Kalman sub-filters, respectively.

According to an optional aspect, such a location is suitable for enabling parallel navigation by distinct Kalman filters, namely via the navigation solutions 60 associated with the N Kalman sub-filters SF₁, SF₂, . . . . SFᵢ, SFᵢ₊₁, . . . . SF_{N} and via the navigation solutions 62 correspondingly associated with the main Kalman filter 32.

In parallel with step 72, or successively with step 72 or vice versa (i.e. before step 72), a step 74 for verifying the reliability of said positioning measurements by GNSS satellites is implemented by the device 10 for maintaining reliability of the positioning of a vehicle irrespective of the vulnerability of satellite data according to the present invention.

According to a particular embodiment illustrated by FIG. 2, said verification 74 comprises in particular a sub-step 76 of determination of:
the state of each sub-filter, when the sub-filter considered does not implement an intermittent hybridization, according to a resetting frequency F_{R} within a predetermined frequency range, of satellite positioning data provided by said receiver and non-satellite positioning data provided at least by said inertial measurement unit, said resetting frequency being distinct from one sub-filter to another, and
the state of the main Kalman filter, between two successive time instants and n and n+1, and of the difference E between the state of each sub-filter and the state of the main Kalman filter.

Optionally, said verification step 74 also comprises a sub-step 78 of determining a threshold S suitable for being compared with the difference E between the state of each sub-filter and the state of the main Kalman filter.

As an alternative (not shown) to the sub-step 78 of determination of a threshold S, said threshold S is directly provided and determined outside said device 10 for maintaining the reliability of the positioning of a vehicle irrespective of the vulnerability of satellite data.

Then, during step 80, the navigation and positioning device 10 according to the present invention implements the comparison to said threshold S, at each moment n+1, of the difference E, between the state of the main Kalman filter 32 and the state of each sub-filter SF₁, SF₂, . . . . SFᵢ, SFᵢ₊₁, . . . . SF_{N} which is not in the process of intermittent hybridization according to a resetting frequency F_{Ri} lying within a predetermined frequency range, of satellite positioning data provided by said receiver and non-satellite data provided by at least one said inertial measurement unit, said resetting frequency being distinct from one sub-filter to another.

In other words, if, at the moment n+1, the sub-filter SFᵢ is considered to be in the process of intermittent hybridization (i.e. of resetting on a GNSS solution), the sub-filter SFᵢ is ignored during said comparison.

During a step 82, the raising of an alarm A is either triggered or not triggered.

More precisely, in the absence of a difference greater than said predetermined threshold S, said absence being represented by the branch 84, no alarm is raised, and during a sub-step 86, the device 10 for maintaining the reliability of the positioning of a vehicle irrespective of the vulnerability of satellite data then implements the determination R_P of a radius of protection against a vulnerability of said positioning measurements by GNSS satellites, said radius of protection ensuring that the value of the distance between the hybrid position provided from said main Kalman filter 32 and the true position of said vehicle is less than the value of said radius of protection, said radius of protection depending on the number Kalman sub-filters.

On the other hand, in the presence of a difference greater than said predetermined threshold, said presence being represented by the branch 88, the raising of an alarm suitable for signaling a vulnerability of said positioning measurements by GNSS satellites at said moment n+1 is triggered, as is a subsequent step 90 of reconfiguration of the device 10 for maintaining the reliability of the positioning of a vehicle irrespective of the vulnerability of satellite data.

Step 90 comprising a first sub-step 92 of reconfiguration R1 of the main Kalman filter 32 on a predetermined Kalman sub-filter of index p with 1≤p≤N, a second sub-step 94 of reconfiguration R2 of each Kalman sub-filter of index i≠p on said predetermined Kalman sub-filter of index p, a third sub-step 96 of GNSS_D deselection of the input of the main Kalman filter dedicated to positioning measurements by GNSS satellites from the moment when the main Kalman filter initiates the reconfiguration thereof.

Steps of said method 70 according to the present invention are described in greater detail hereinafter.

More particularly, during the sub-step 76, the difference

$$E = {V}_{X} = {X}_{n + 1 / n}^{SF} - {X}_{n + 1 / n}$$

between the state of each sub-filter (when said sub-filter considered does not implement an intermittent hybridization) and the state of the main Kalman filter is determined because a GNSS measurement is erroneous, same will corrupt the primary INS/GNSS solution coming from the main Kalman filter 32, but not certain solutions coming from the sub-solutions provided by the N sub-filters suitable for performing a time-shifted resetting according to the present invention. Such a difference between the different solutions correspondingly associated with the different filters of the Kalman filter set K will result in a difference between the position states of the sub-filter

$${X}_{n + 1 / n}^{SF}$$

and of the primary filter X_{n+1/n} that has a variable importance depending on the state studied, and inconsistent with the covariance of the difference of the states, the position states X in question corresponding e.g. to states of heading, speed, position, etc.

During the sub-step 80, one seeks to check, over time and for each sub-filter, the difference

$$E = {V}_{X} = {X}_{n + 1 / n}^{SF} - {X}_{n + 1 / n}$$

by comparing same, via a predetermined threshold, with the covariance of the difference of the states.

Indeed, considering that the observation matrices of each sub-filter H^{SF} and of measurement noise R^{SF} are sub-matrices of the observation matrices H and measurement noise matrices R of the main Kalman filter 32 where the rows (columns respectively) related to the GNSS measurements have been set to zero (the rest being identical between the sub-filter and the primary filter), and that the propagation F and model noise Q matrices are identical between the sub-filter and the primary filter, then it is demonstrable by recurrence, by a person skilled in the art, that the expectancy (X.X^{SF}^{^{T}}) is equal to the difference of covariance matrix P^{SF}−P, which, by development, is equivalent to an expectancy of ((X−X^{SF}) (X−X^{SF})^{T}) equal to P the covariance matrix of the main Kalman filter 32.

According to an optional supplementary aspect, as described hereinabove, the device 10 for maintaining the reliability of the positioning of a vehicle irrespective of the vulnerability of satellite data according to the present invention determines as such, during step 78, said threshold used to compare the difference

$$E = {V}_{X} = {X}_{n + 1 / n}^{SF} - {X}_{n + 1 / n}$$

with the covariance of the difference of the states.

More particularly, during the sub-step 78, according to a probability of false alarm noted by P_{fα}, one seeks to establish a real threshold value such as:

$${V}_{X} = {X}_{n + 1 / n}^{SF} - {X}_{n + 1 / n} = {K}_{fa} \cdot \sqrt{E ( ( {X}_{n + 1 / n} - {X}_{n + 1 / n}^{SF} ) {( {X}_{n + 1 / n} - {X}_{n + 1 / n}^{SF} )}^{T} )} = {K}_{fa} \cdot \sqrt{( {P}_{n + 1 / n}^{SF} - {P}_{n + 1 / n} )}$$

$${P}_{n + 1 / n}^{SF}$$

and P_{n+1/n} being provided respectively, by the Kalman sub-filter considered and by the primary Kalman sub-filter (when said considered sub-filter does not implement an intermittent hybridization), the Kalman sub-filter containing less information than the main Kalman filter 32, then by construction

$${P}_{n + 1 / n}^{SF} \geq {P}_{n + 1 / n} .$$

Furthermore, the difference

$${X}_{n + 1 / n}^{SF} - {X}_{n + 1 / n}$$

also follows, by the construction of the Kalman filters, a centered Gaussian law with standard deviation \sqrt{P^{SF}−P}. Considering e.g. a distribution of a Gaussian law centered at zero and with a standard deviation equal to one. The detection threshold is chosen for the example so that for 1% of the time, an error is detected that is not present (P_{fα}=0.01), which leads in the example to K_{fα}=1.96, which means mathematically, for a variable X centered and of standard deviation equal to one, that:

$${\int }_{- {K}_{fa}}^{{K}_{fa}} \frac{1}{\sqrt{2 π}} {e}^{- {X}^{2}} dX \geq 1 - {P}_{fa} ,$$

and thus a threshold S such that:

$$S = {K}_{fa} \cdot \sqrt{( {P}_{n + 1 / n}^{SF} - {P}_{n + 1 / n} ) .}$$

Thereby, as illustrated by the test sub-step 82, when

$${V}_{X} < S = {K}_{fa} \cdot \sqrt{( {P}_{n + 1 / n}^{SF} - {P}_{n + 1 / n} )} ,$$

according to branch 84, no alarm is raised because there is then no problem detected on the GNSS measurements.

On the other hand, according to branch 88, when

$${V}_{X} \geq S = {K}_{fa} \cdot \sqrt{( {P}_{n + 1 / n}^{SF} - {P}_{n + 1 / n} )} ,$$

an anomaly on GNSS measurements is detected and an alarm is raised.

It should be noted that the test 82 is performed, depending on the application, on certain controlled states such as position, speed, attitudes, sensor fault states, etc., for the N sub-filters of the architecture.

As indicated hereinabove, in the absence 84 of a difference greater than said predetermined threshold S, no alarm is raised, and during a sub-step 86, the device 10 for maintaining the reliability of the positioning of a vehicle irrespective of the vulnerability of satellite data then implements the determination of a radius of protection against a vulnerability of said positioning measurements by GNSS satellites, said radius of protection ensuring that the value of the distance between the hybrid position provided from said main Kalman filter 32 and the true position of said vehicle is less than the value of said radius of protection, said radius of protection depending on the number Kalman sub-filters.

To determine such a radius of protection, which is entirely predictive, from the covariances of the main Kalman filter 32 and of the Kalman sub-filters SF₁, SF₂, . . . . SFᵢ, SFᵢ₊₁, . . . . SF_{N}, the device 10 for maintaining the reliability of the positioning of a vehicle irrespective of the vulnerability of satellite data adds in a probability of non-detection P_{nd}.

In particular, taking as an example, the latitude state noted by Xₗₐₜ, the radius of protection Rₚ is then defined as follows:

$$P ( {\sum }_{N} ( {V}_{{X}_{lat}} < {K}_{fa} \cdot \sqrt{( {P}_{lat}^{SF} - {P}_{lat} )} ) ⋂ \vert {X}_{lat} - {lat}_{true} \vert > {R}_{p} ) < {P}_{nd}$$

with Σ_{N} the sum over the N Kalman sub-filters, Pₗₐₜ the diagonal of the covariance matrix corresponding to the latitude stateXₗₐₜ.

Considering the simplest case where N=1, which means using a single Kalman sub-filter, |Xₗₐₜ−latₜᵣᵤₑ| is limited by the state of the Kalman sub-filter which potentially can detect the GNSS failure (i.e. a vulnerability of GNSS measurements):

$$\vert {X}_{lat} - {lat}_{true} \vert \leq \vert {X}_{lat} - {X}_{lat}^{SF} \vert + \vert {X}_{lat}^{SF} - {lat}_{true} \vert$$

$$\vert {X}_{lat} - {lat}_{true} \vert \leq {V}_{{X}_{lat}} + \vert {X}_{lat}^{SF} - {lat}_{true} \vert$$

Moreover, as seen hereinabove, at the moment of detection

$${V}_{{X}_{lat}} = {K}_{fa} \cdot \sqrt{( {P}_{lat}^{SF} - {P}_{lat} )} ,$$

so that the whole issue of the radius of protection Rₚ_{ₗₐₜ} lies in the fact that at the same moment of detection:

$$\vert {X}_{lat} - {lat}_{vraie} \vert \leq {V}_{{X}_{lat}} + \vert {X}_{lat}^{SF} - {lat}_{true} \vert \leq {K}_{fa} \cdot \sqrt{( {P}_{lat}^{SF} - {P}_{lat} )} + \vert {X}_{lat}^{SF} - {lat}_{true} \vert \leq {R}_{{p}_{lat}} .$$

Then by taking

$${R}_{{p}_{lat}} = {K}_{fa} \cdot \sqrt{( {P}_{lat}^{SF} - {P}_{lat} )} + \vert {X}_{lat}^{SF} - {lat}_{vraie} \vert ,$$

and considering that

$$\vert {X}_{lat}^{SF} - {lat}_{vraie} \vert$$

follows a centered Gaussian law of standard deviation

$$\sqrt{{P}_{lat}^{SF}} .$$

The determination of the radius of protection means looking for the coefficient K_{nd} such that:

$${\int }_{- ∞}^{{K}_{nd}} \frac{1}{\sqrt{2 π {P}_{lat}^{SF}}} {e}^{- \frac{{X}_{lat}^{2}}{{P}_{lat}^{SF}}} dX \geq 1 - {P}_{nd} ,$$

so that it is then possible to guarantee that if the difference

$$\vert {X}_{lat}^{SF} - {lat}_{true} \vert$$

is less than

$${K}_{nd} \sqrt{{P}_{lat}^{SF}} ,$$

at the time of the GNSS failure, then

$$\vert {X}_{lat}^{} - {lat}_{true} \vert \leq {R}_{Plat}$$

with a non-detection probability for the failure of P_{nd} and then:

$${R}_{Plat} = {K}_{fa} \cdot \sqrt{( {P}_{lat}^{SF} - {P}_{lat} )} + {K}_{nd} \sqrt{{P}_{lat}^{SF}}$$

Considering the most complex case according to which N≠1, which means using a plurality of Kalman sub-filters, making no assumption about the duration of the failure except that the failure cannot be detected during Tᵢ_{ₘₐₓ}, where Tᵢ_{ₘₐₓ} is the maximum resetting period of the periods

$${T}_{i} = \frac{1}{{F}_{Ri}}$$

corresponding to the resetting period of each sub-filter of index i, then the radius of protection preferentially corresponds to the maximum value of the protection radii of each of the sub-filters such that:

$${R}_{Plat} = {max}_{N} ( {K}_{fa} \cdot \sqrt{( {P}_{lat}^{SF} - {P}_{lat} )} + {K}_{nd} \sqrt{{P}_{lat}^{SF}} )$$

as long as the detection of the fault has not raised an alarm. As soon as the alarm is raised, the radius of protection can propagate with the error value as follows:

$${R}_{Plat} = {max}_{N} ( \vert {X}_{lat}^{} - {X}_{lat}^{SF} \vert + {K}_{nd} \sqrt{{P}_{lat}^{SF}} )$$

so that it is then preferable to stop the resetting mechanism by intermittent hybridization with the satellite data 24 of each Kalman sub-filter SF₁, SF₂, . . . . SFᵢ, SFᵢ₊₁, . . . . SF_{N} at a resetting frequency F_{Ri} comprised within a predetermined frequency range.

It should be noted that the previous example of determination of the radius of protection developed from the latitude state can be generalized to other states such as other position (longitude, altitude) states or else to speed states or attitude states and heading states.

With regard to the reconfiguration sub-step 90, it should be noted that the architecture of the proposed Kalman filter set K has the ability to propose a navigation solution that is not corrupted by the GNSS failure. Indeed, once the alarm has been lifted, just as the Kalman sub-filters SF₁, SF₂, . . . . SFᵢ, SFᵢ₊₁, . . . . SF_{N} were, prior to the raising of alarm, reconfigured periodically and offset on the main Kalman filter 32, it is possible to reconfigure the main Kalman filter 32 on a non-corrupted Kalman sub-filter, the choice of which is suitable for depending on the desired application, a preferential and conservative choice being to take the Kalman sub-filter the implementation of said intermittent hybridization of which (i.e. the resetting by intermittently using the GNSS data 24) is the farthest, in terms of time, from the moment of raising of alarm, assuming that the GNSS failure could not be detected during Tᵢ_{ₘₐₓ}, where Tᵢ_{ₘₐₓ} is the maximum duration period amongst the periods

$${T}_{i} = \frac{1}{{F}_{Ri}}$$

corresponding to the resetting period of each sub-filter of index i. Thereby, during the reconfiguration, the covariance matrix of the main Kalman filter 32 is overwritten by the matrix of the selected healthy sub-filter.

It should be noted that the positioning performance obtained by means of each sub-filter is suitable to be evaluated by means of a Circular Error Probability, e.g. a CEP₅₀ corresponding to a circular error probable at 50%, which is equivalent to the radius of the circle within which 50% of the values of a two-dimensional measurement sample are found. More particularly, a resetting on a solution using satellite data, lasting one hundred seconds, for an implementation of the resetting by intermittent hybridization at a frequency of once every twenty-four hours makes it possible to cancel (or at least to decrease) intermittently and periodically (i.e. every twenty-four hours) the value of the CEP₅₀ which, as soon as the resetting ends, increases again because same represents the drift of the Kalman sub-filter when same does not use the satellite data outside the hundred seconds of resetting.

A person skilled in the art would understand that the invention is not limited to the embodiments described, nor to the particular examples of the description, the above-mentioned embodiments and variants being suitable for being combined with one another so as to generate new embodiments of the invention.

The present invention thereby proposes an architecture of a set of Kalman filters with time-shifted resetting due to a resetting frequency distinct from a sub-filter to another allowing the reliability of the positioning to be maintained irrespective of the vulnerability of GNSS measurements by comparison
on the one hand, of the primary position resulting from the classical ins/GNSS hybridization carried out through a main Kalman filter 32 using as input all the available measurements: GNSS, external position, zero displacement resetting when the vehicle is stationary, measurement of electromagnetic Loch and a dynamic model of the vehicle, Doppler loch or DVL, depth measurement, radar resetting, imaging, opportunity signal resetting, etc.
with, on the other hand, a subset of secondary positions provided by a bank of N Kalman sub-filters not using at input any GNSS measurement for a certain period of time (apart from the implementation of said intermittent hybridization according to a resetting frequency F_{Ri} comprised within a predetermined frequency range, of satellite positioning data provided by said receiver and of non-satellite positioning data provided at least by said inertial measurement unit, said resetting frequency being distinct from one sub-filter to another), which means using partial measurements.

Such a check is not only carried out on a single satellite at a time, which prevents limiting the field of application.

In addition, the device 10 for maintaining the reliability of the positioning of a vehicle irrespective of the vulnerability of satellite data, is according to an optional aspect, suitable for permanently proposing a set of navigation solutions, a part of which has not used GNSS measurements since a certain time, typically from several hours to several days.

Furthermore, according to an optional variant of embodiment, the device 10 for maintaining the reliability of the positioning of a vehicle irrespective of the vulnerability of satellite data is also suitable for providing a radius of protection against a vulnerability of the GNSS measurements and apt to initiate a reconfiguration of the main Kalman filter on a solution of a healthy Kalman sub-filter if a vulnerability of the GNSS measurements is detected. Thereby, a healthy fallback solution is always available if a problem is detected on the GNSS signals.

In other words, the present invention makes it possible to maintain the integrity of the location, to warn when the GNSS signals are not reliable, to reconfigure itself on a solution not tainted by the vulnerability of the GNSS measurements, in other words, to reconfigure the main Kalman filter on a “healthy” Kalman sub-filter, and to have available, a panel of navigation solutions deduced from Kalman sub-filters that have navigated without the GNSS measurement since a variable time.

1. A device (10) for maintaining reliability of positioning of a vehicle irrespective of vulnerability of satellite data, carried on-board a vehicle moving between two distinct geographical positions, the device comprising:
an inertial measurement unit providing navigation measurements;
a receiver of satellite positioning data;
a closed-loop main Kalman filter calculating navigation data corrections by continuous hybridization of satellite positioning data provided by said receiver and non-satellite positioning data provided by at least said inertial measurement unit; and
a bank of Kalman sub-filters in parallel, each Kalman sub-filter:
calculating navigation data corrections by intermittent hybridization, according to a resetting frequency comprised within a predetermined frequency range, of satellite positioning data provided by said receiver and non-satellite positioning data provided at least by said inertial measurement unit, the resetting frequency being distinct from one sub-filter to another, and
outside the implementation of the intermittent hybridization, calculating navigation data corrections solely from the non-satellite positioning data provided by at least said inertial measurement unit.

2. The device according to claim 1, wherein said Kalman sub-filters are identical and independent, the period corresponding to a verification period of the reliability of the positioning measurements by GNSS satellites.

3. The device (10) according to claim 2, wherein the device checks the reliability of the positioning measurements by GNSS satellites by comparing, with a predetermined threshold, the difference between the state of each sub-filter, outside the implementation of the intermittent hybridization, and the state of said main Kalman filter, and, in case of difference greater than the predetermined threshold, raises an alarm suitable for signaling a vulnerability of the positioning measurements by GNSS satellites.

4. The device according to claim 3, wherein the device determines the predetermined threshold as a function of a probability of false alarm.

5. The device (10) according to claim 3, wherein, in the event of raising an alarm, said main Kalman filter reconfigures itself on a predetermined Kalman sub-filter.

6. The device according to claim 5, wherein the predetermined Kalman sub-filter on which said main Kalman filter reconfigures itself in the event of raising an alarm, is the Kalman sub-filter among said Kalman sub-filters the implementation of which of the intermittent hybridization is the farthest, in terms of time, from the moment of raising the alarm.

7. The device (10) according to claim 5, wherein said main Kalman filter no longer inputs the positioning measurements by GNSS satellites from the moment when said main Kalman filter initiates reconfiguration.

8. The device according to claim 5, wherein in the event of raising an alarm, each Kalman sub-filter other than the predetermined sub-filter is also configured to reconfigure itself to the predetermined Kalman sub-filter.

9. The device according to claim 1, wherein the device determines a radius of protection against vulnerability of the positioning measurements by GNSS satellites, the radius of protection ensuring that the value of the distance between the hybrid position provided from said main Kalman filter and the true position of the vehicle is less than the value of the radius of protection, the radius of protection depending on the number of Kalman sub-filters.

10. The device according to claim 1, wherein the device provides, at the output, in parallel, navigation solutions associated with said bank of Kalman sub-filters and said main Kalman filter, respectively.
